(19) United States
(12) Patent Application Publication
(10) Pub. No.: US 2003/0159265 A1
(43) Pub. Date: Aug. 28, 2003

(54) Method for manufacturing great quatity of a composite storage tank

(76) Inventor: Dong Ki Lee, Seoul (KR)

Correspondence Address: BIRCH STEWART KOLASCH & BIRCH, PO BOX 747, FALLS CHURCH, VA, 22040-0747, US

(21) Appl. No.: 10/312,399

(22) PCT Filed: Jun. 26, 2001
(86) PCT No.: PCT/KR01/01091

(51) Int. Cl. B23P 11/00

(52) U.S. Cl. 29/428

(57) ABSTRACT

The present invention relates to a method for manufacturing great quantity of a composite storage tank characterized in that great quantity of main body (1) and assemblies joining together the main body (1) are extruded using a thermoplastic synthetic resin, the main body and assemblies are contacted with each other perpendicularly, the contact parts are welded by a fillet welding method or a butt welding method to give great quantity of a composite storage tank. The method in accordance with the present invention has many features such as a process for manufacturing is easy and convenience, working time for the manufacture is short, standardized articles can he produced in large amount in short period, man powers and materials for manufacturing them are saved and so forth.

### TECHNICAL FIELD

The present invention relates to a method for manufacturing great quantity of a composite storage tank having multiple storage spaces being used as a tank for treating and discharging sewage and wastewater come from residential areas or industrial facilities below permitted limit for discharge by means of a biological or a chemical treatment process, being used as a clean water tank treating cleanly underground water passing through multiple steps and being used as a tank for preserving and treating separately various stocks, more particularly relates to a method for manufacturing great quantity of a composite storage tank having separated multiple storage spaces using recyclable materials such as thermoplastic synthetic resins.

### BACKGROUND ART

In conventional storage tanks for treating sewage and wastewater passing through multiple steps, small water-purifier tanks for treating night soil are manufactured by assembling segments forming a cylindrical main body made from thermoplastic synthetic resins such as polyethylene or polypropylene and great quantity of composite storage tanks for purifing and storing sewage and wastewater are made from fibre glass reinforced plastics as a thermoset by manually or are made from cement mortar and then their surfaces are waterproofed.

More particularly said small water-purifier tank for treating night soil made from thermoplastic synthetic resin such as polyethylene or polypropylene are manufactured by butt seam welding, panels of multiple segments extruded by using the resins, using press welding devices, to give a cylindrical main body of the tank and then the internal partitions and the external side plates are assembled with said main body by the butt seam welding.

Accordingly it is difficult or impossible to manufacture a great quantity(diameter) of water-purifier tanks by menas of the above-stated method.

Thus in conventional method for manufacturing the great quantity of water-purifier tanks, as shown in FIG. 4, a main body 10 of a water-purifier tank is manufactured manually using fibre glass reinforced forced plastics(FRP), subsidiary assemblies such as external side plates 20,20′ and internal partitions 30,30′ also are manufactured using the FRP, then said main body 10 and subsidiary assemblies are assembled by inserting or folding and on the assembled part the other FRP layer is coated manually to give a complete water purifier tank, or the water purifier tank is manufactured by cement mortar in a mold.

However in case of the above-mentioned method many man powers are necessary and manufacturing period are lengthened, particularly in case that is made from the FRP, in its manufacturing process or in its scrapping process pollutive materials are generated, it is impossible to recyle it and also because the FRP products have thin thickness in the winter activity of microorganisms in the water purifier tank is stopped or reduced, thereby purifing effect is reduced.

### DISCLOSURE OF INVENTION

The present invention is to provide a method for manufacturing composite storage tank for purifing a sewage and a wastewater that, to solve many problems in method for manufacture a conventional sewage purifing tank and great quantity of a storage tank for purifing sewage and wastewater, their manufacture is convenient, they can be manufactured in short period, environmental pollution is not generated in process for manufacturing or changing them, scraps given in process for manufacturing or changing them may be recycled and when they are laid under the ground they can get over earth pressure substantially.

The disclosure of method for manufacturing them are as follows;

A method for manufacturing great quantity of a composite storage tank of the present invention comprises that a flat band is extruded using any one of thermoplastic synthetic resins such as polyethylene or polypropylene, said extruded flat band is overlapped in multiple layers on a cylinderical mold to give a cylindrical main body of a tank or a □ shaped tube is extruded using said resins, the extruded □ shaped tube is wound continuously in screw shape on a cylindrical mold, the moment the folded part of the tube is fused by heating to give a cylindrical main body of tank having a structure of a double wall, and assemblies for the tank such as multiple internal partitions, external side plates or manholes also are extruded using the above-mentioned resins, the assemblies are contacted perpendicularly on relevant positions of said tank and then using resins identical to those used in molding the main body and the assemblies of said tank the contacted parts are welded.

### BRIEF DESCRIPTION OF DRAWINGS

FIG. 1 is a vertical section view of a composite storage tank manufactured in accordance with the present invention.

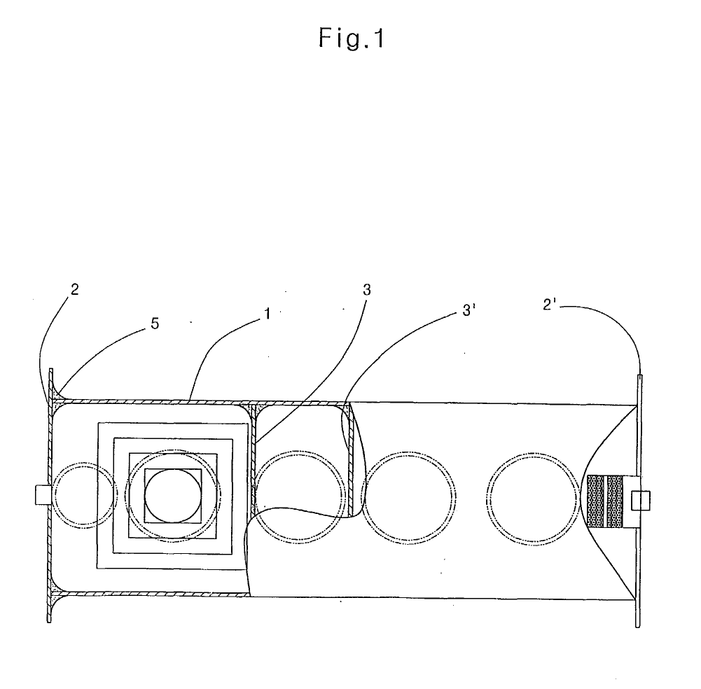

FIG. 2 is a vertical section view of the other composite storage tank manufactured in accordance with the present invention.

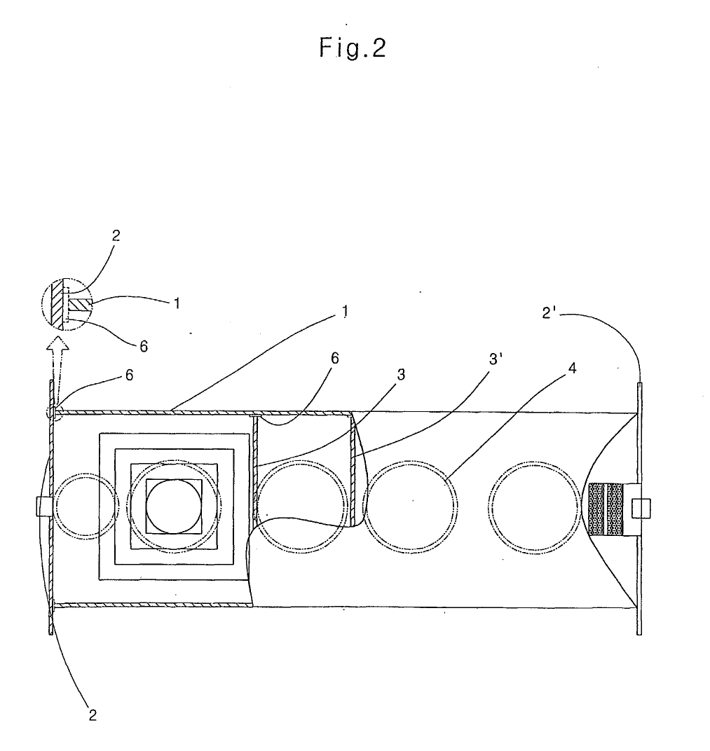

FIG. 3 is a vertical section view of another composite storage tank manufactured in accordance with the present invention.

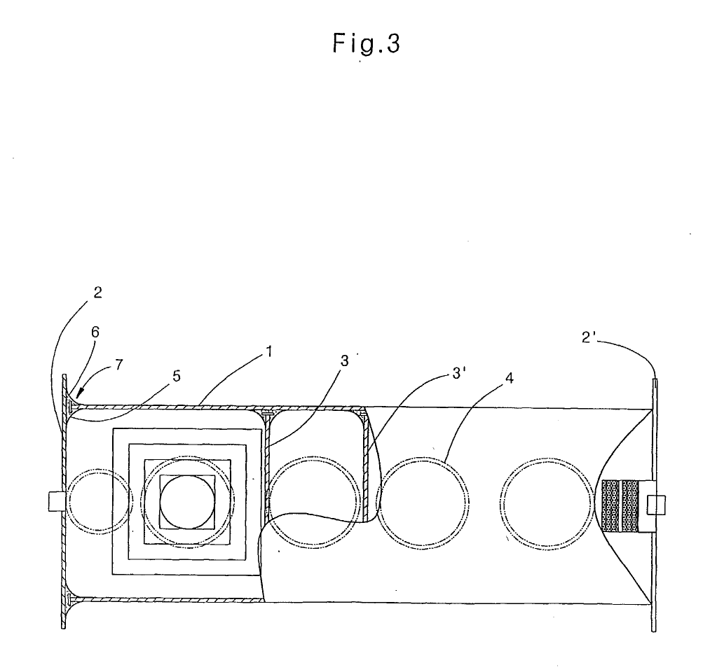

FIG. 4 is a vertical section view of conventional water purifier tank manufactured using fibre glass reinforced plastic.

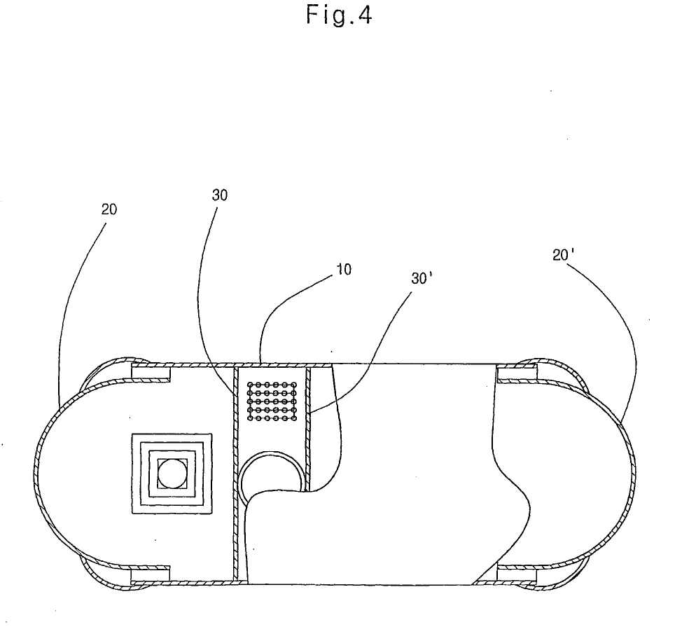

### BEST MODE FOR CARRYING OUT THE INVENTION

Now referring to the accompanying drawings the present invention is described in detail.

The present invention characterized in that in method for manufacturing great quantity of a composite storage tank having multiple storage spaces comprising a main body 1 of pipe shape having a great diameter, external side plates 2.2′ welding on both ends of said main body 1, internal partitions 3.3′ seperated each store room, manholes 4 and so forth, a great quantity of main body 1 having a great diameter is extruded in a pipe shape using any one selected from conventional thermoplastic synthetic resins such as polyethylene or polypropylene, assemblies joining together the main body 1 such as external side plates 2.2′, internal partitions 3.3′, manholes 4 and so forth also are extruded using the resin identical to that used in manufacturing said main body 1, then said assemblies are contacted with said main body 1 perpendicularly, and said contact parts are welded by any one of welding methods selected from a fillet welding method 7 that the contact parts are heated blowing hot wind in higher temperature than melting point of the resin by mean of a hot wind welding machine, the moment thermoplastic synthetic resin identical to those used in manufacturing main body 1 and assemblies of said tank is provided by extrusion on said contact part by means of a small hot wind extruding welder and then the provided resin is pressed to weld the contact parts completedly, or a butt welding method 6 that between the contact parts of said main body 1 and the assemblies a heating plate is inserted, after the plate is heated so as to melt said both contact parts by means of the heated plates, the heated plate is removed, the moment both melted contact parts are adhered, to give great quantity of a composite storage tank.

### INDUSTRIAL APPLICABILITY

When the great quantity of the composite storage tank having a multiple storage spaces is manufactured in accordance with the method of the present invention, there are many features such as a working time for manufacture is very short, standardized articles can be produced in large quantities within short period, environmental pollution is not generated, the products are firm, materials for manufacturing the products are required in small amount, labor cost is reduced, scraps and waste articles can be recycled.

What is claimed is:

1. In a method for manufacturing great quantity of a composite storage tank comprising a main body 1 of pipe shape having a great diameter, external side plates 2.2′ welding on both ends of said main body 1, internal partitions 3.3′ seperated each store room, manholes 4 and so forth, a method for manufacturing great quantity of a composite storage tank characterized in that a main body 1 having a great diameter is extruded in a pipe shape using any one selected from conventional thermoplastic synthetic resins such as polyethylene or polypropylene, assemblies joining together the main body 1 such as external side plates 2.2′, internal partitons 3.3′,manholes 4 and so forth also are extruded using the resin identical to that used in manufacturing said main body 1, then said assemblies are contacted with said main body 1 perpendicularly and said contact parts are welded by any one of welding methods selected from a fillet welding method 7 that the contact parts are heated blowing hot wind in higher temperature than melting point of the resin by mean of a hot wind welding machine, the moment thermoplastic synthetic resin identical to those used in manufacturing main body 1 and assemblies of said tank is provided by extrusion on said contact part by means of a small hot wind extruding welder and then the provided resin is pressed to weld the contact parts completedly, or a butt welding method 6 that between the contact parts of said main body 1 and the assemblies a heating plate is inserted, after the plate is heated so as to melt said both contact parts by means of the heated plates, the heated plate is removed, the moment both melted contact parts are adhered, to give great quantity of a composite storage tank.

2. In a method for manufacturing great quantity of a composite storage tank comprising a main body 1 of pipe shape having a great diameter, external side plates 2.2′ welding on both ends of said main body 1, internal partitions 3.3′ seperated each store room, manholes 4 and so forth, a method for manufacturing great quantity of a composite storage tank characterized in that a main body 1 of a pipe shape having a great diameter extruded using any one selected from conventional thermoplastic synthetic resins such as polyethylene or polypropylene is contacted perpendicularly with assemblies such as external side plates 2.2′, internal partitions 3.3′, manholes 4 and so forth and said contact parts are welded using thermoplastic synthetic resin identical to those used in manufacturing main body 1 and assemblies of said tank, to give great quantity of a composite storage tank.
